(19) United States
(12) Patent Application Publication
(10) Pub. No.: US 2011/0158852 A1
(43) Pub. Date: Jun. 30, 2011

(54) OFFSET PATH MIXERS AND FLUID SYSTEMS INCLUDNG THE SAME

(76) Inventors: Gustavo H. Castro, Cottage Grove, MN (US); Paul J. Cobian, Woodbury, MN (US)

(21) Appl. No.: 13/054,129

(22) PCT Filed: Jul. 15, 2009
(86) PCT No.: PCT/US2009/050696

§ 371 Date: Mar. 8, 2011

Related U.S. Application Data
(60) Provisional application No. 61/081,884, filed on Jul. 18, 2008.

(51) Int. Cl. G01N 30/00; B01F 5/06

(52) U.S. Cl. 422/69; 366/340; 366/338

(57) ABSTRACT

Static mixers and fluid systems incorporating one or more of the static mixers. The static mixers include one or more channels that provide a fluid path through a body, wherein fluid flowing through each channel defines a downstream direction through the channel. The channel includes two or more sets of concatenated mixing elements arranged adjacent to each other across the width of the channel, wherein two sets of the mixing elements are offset from each other along the downstream direction of the channel.

### CROSS REFERENCE TO RELATED APPLICATIONS

This application claims the benefit of U.S. Provisional Patent Application No. 61/081,884, filed Jul. 18, 2008, which is incorporated herein by reference.

Efficient and thorough mixing of materials is a need that is addressed by many different static and dynamic mixers, although many conventional mixers used to mix small volumes of materials often rely on electrical or magnetic fields, long micro-channels or generation of alternating adjacent fluid layers with thicknesses in the micrometer (μm) range (e.g., 25-40 μm) (where the fluid layers are redirected such that they mix). In many instances, however, the mixers suffer from issues such as relatively high pressure drop, limited flow rates, inefficient mixing, etc.

### SUMMARY OF THE INVENTION

The present invention provides static mixers and fluid systems incorporating one or more of the static mixers. The static mixers preferably include one or more channels that provide a fluid path through a body, wherein fluid flowing through each channel defines a downstream direction through the channel. The channel preferably includes two or more sets of concatenated mixing elements arranged adjacent to each other across the width of the channel.

The mixing elements in each set of mixing elements include an upstream panel and a downstream panel in a wave-like arrangement in which the upstream panel extends from the bottom surface of the channel to the top surface of the panel and the upstream panel extends from the top surface of the channel to the bottom surface of the channel. At least one of the upstream or downstream panels in each mixing element includes an opening formed through the panel through which at least a portion of the fluid can flow.

The sets of mixing elements are preferably offset from each other along the length of the channel such that similar elements of the different adjacent sets of mixing elements are not aligned with each other across the width of the channel. The offset alignment may preferably result in alignment of the upstream panels of most of the first mixing elements being located adjacent (across the width of the channel) from the downstream panels of the second mixing elements.

The offset arrangement of the different sets of mixing elements preferably causes fluids moving through the channel from the inlet to the outlet to travel paths that move in three dimensions to enhance mixing of the fluids within the channel.

It may be preferred that the static mixers of the present invention be capable of mixing small microfluidic volumes of fluids. As used herein, microfluidic static mixers include channels that have, e.g., a cross-sectional area (taken in a plane perpendicular to the downstream flow direction) on the order of 125,000 square micrometers (s-μm) or less. Furthermore, it may be preferred that microfluidic static mixers be capable of mixing fluids with Reynolds numbers in the range of one (1) or less (e.g., Re≦1).

One potential advantage of the mixers of the present invention may include, e.g., a reduction in non-specific binding of analytes to the mixing structures which may be beneficial in connection with biological materials passed through the mixers. In part, the non-specific binding may be reduced by the relatively small surface area to which the biological materials are exposed.

Another potential advantage of the mixers of the present invention is an ability to process smaller sample volumes because of a reduction in the amount of dead volume in the mixers of the present invention.

In one aspect, the present invention provides a static mixer having a mixing structure formed within a body. The mixing structure includes a channel having a bottom surface and a top surface, wherein fluid flowing through the channel defines a flowpath comprising a downstream direction through the channel from an inlet where the fluid enters the channel to an outlet where the fluid exits the channel, and wherein the channel has a length from the inlet to the outlet, a width oriented generally transverse to the length, and a height oriented generally transverse to both the length and the width. The mixing structure also includes a set of first mixing elements arranged sequentially along the length of the channel, wherein each first mixing element has a first mixing element length that extends from an upstream end of the first mixing element to a downstream end of the first mixing element. Each first mixing element further includes an upstream panel extending from the bottom surface of the channel at the upstream end of the first mixing element to the top surface of the channel at a first intermediate location that is between the downstream end and the upstream end of the first mixing element; a downstream panel extending from the top surface of the channel to the bottom surface of the channel, wherein the downstream panel meets the bottom surface of the channel at the downstream end of the first mixing element, and wherein the downstream panel extends from the top surface of the channel at the first intermediate location where the upstream panel meets the top surface or downstream thereof; and one or more openings formed through the downstream panel, wherein fluid can flow through the opening in the downstream panel.

The mixing structure also includes a set of second mixing elements arranged sequentially along the length of the channel, wherein each second mixing element has a second mixing element length that extends from an upstream end of the second mixing element to a downstream end of the second mixing element. Each second mixing element further includes an upstream panel extending from the bottom surface of the channel at the upstream end of the second mixing element to the top surface of the channel at a second intermediate location that is between the downstream end and the upstream end of the second mixing element; a downstream panel extending from the top surface of the channel to the bottom surface of the channel, wherein the downstream panel meets the bottom surface of the channel at the downstream end of the second mixing element, and wherein the downstream panel extends from the top surface of the channel at the second intermediate location where the upstream panel meets the top surface or downstream thereof; and one or more openings formed through the upstream panel of the second mixing element, wherein fluid can flow through the opening in the upstream panel. The set of first mixing elements and the set of second mixing elements are arranged side-by-side across the width of the channel; wherein the set of first mixing elements and the set of second mixing elements are offset from each other along the length of the channel such that the second intermediate locations of the set of second mixing elements are positioned downstream from the first intermediate locations of the set of first mixing elements when moving through the channel in the downstream direction.

In various embodiments, the static mixers of the present invention may include one or more of the following features: the downstream panel of each of the first mixing elements may extend from the top surface of the channel at the first intermediate location where the upstream panel meets the top surface; the downstream panel of each of the second mixing elements may extend from the top surface of the channel at the second intermediate location where the upstream panel meets the top surface; for each of the first mixing elements located between an upstream first mixing element and a downstream first mixing element, the upstream panel may extend from the bottom surface of the channel where the downstream panel of the upstream first mixing element meets the bottom surface; for each of the second mixing elements located between an upstream second mixing element and a downstream second mixing element, the upstream panel may extend from the bottom surface of the channel where the downstream panel of the upstream second mixing element meets the bottom surface; for each of the second mixing elements, the downstream panel may extend from the top surface of the channel at the second intermediate location where the upstream panel meets the top surface; wherein the set of first mixing elements and the set of second mixing elements are offset from each other along the length of the channel such that the downstream panels of most of the first mixing elements are aligned with the upstream panels of the second mixing elements across the width of the channel; the set of first mixing elements and the set of second mixing elements are offset from each other along the length of the channel such that the upstream ends of most of the first mixing elements are aligned with the second intermediate locations of the second mixing elements across the width of the channel; wherein the set of first mixing elements occupy a first width across the width of the channel, and wherein the set of second mixing elements occupy a second width across the width of the channel, and further wherein the first width and the second width are substantially equal; wherein the set of first mixing elements occupy a first width across the width of the channel, and wherein the set of second mixing elements occupy a second width across the width of the channel, and further wherein the first width and the second width are different; wherein the first mixing element lengths of the set of first mixing elements are uniform; wherein the second mixing element lengths of the set of second mixing elements are uniform; wherein the uniform first mixing element lengths are substantially equal to the uniform second mixing element lengths; wherein the upstream panels and the downstream panels of the set of first mixing elements are flat structures; wherein the upstream panels and the downstream panels of the set of second mixing elements are flat structures; wherein the upstream panels and the downstream panels of the set of first mixing elements are curved structures; wherein the upstream panels and the downstream panels of the set of second mixing elements are curved structures; wherein the downstream panel of each of the first mixing elements includes only one opening formed therethrough; wherein the upstream panel of each of the second mixing elements includes only one opening formed therethrough; wherein the openings in the downstream panels of the first mixing elements are centered in the downstream panels; wherein the openings in the upstream panels of the second mixing elements are centered in the upstream panels; the body may be a flexible body; the downstream direction may follow a curvilinear path that varies in three dimensions; etc.

In various embodiments, the static mixers may have the following dimensions and/or relationships: in a plane oriented orthogonal to the downstream direction of the static mixer, the channel may have a maximum height between the top surface and the bottom surface of 250 micrometers or less; in a plane oriented orthogonal to the downstream direction of the static mixer, the channel may have a maximum width between the first edge and the second edge of 1000 micrometers or less; the channel may have a maximum open cross-sectional area of 250000 square micrometers or less; in a plane oriented orthogonal to the downstream direction of the static mixer, the channel may have a maximum width between the first edge and the second edge and a maximum height between the top surface and the bottom surface, and further wherein a ratio of the maximum width to the maximum height is 1 or more, 2 or more, etc.; in a plane oriented orthogonal to the downstream direction of the static mixer, the channel may have a maximum width between the first edge and the second edge and a maximum height between the top surface and the bottom surface, and further wherein a ratio of the maximum width to the maximum height is 2 or more and 4 or less.

In another aspect, the present invention may provide an integrated fluid system that includes, in one unitary body, at least the following components: a static mixer according to the present invention; a first chamber located upstream of the static mixer; a second chamber located downstream of the static mixer; and fluid connection channels extending between the static mixer, the first chamber, and the second chamber.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. The term “and/or” (if used) means one or all of the identified elements/features or a combination of any two or more of the identified elements/features.

The term “and/or” means one or all of the listed elements/features or a combination of any two or more of the listed elements/features.

The above summary is not intended to describe each embodiment or every implementation of the present invention. Rather, a more complete understanding of the invention will become apparent and appreciated by reference to the following Detailed Description of Exemplary Embodiments and claims in view of the accompanying figures of the drawing.

### BRIEF DESCRIPTIONS OF THE VIEWS OF THE DRAWING

The present invention will be further described with reference to the views of the drawing, wherein:

FIG. 1 is a perspective view of one example of a body containing a static mixer according to the present invention.

FIG. 2 is a perspective view of one exemplary pair of adjacent sets of mixing elements that may be used in the mixer of FIG. 1, with the sets of mixing elements removed from a channel.

FIG. 3 is an enlarged perspective view of one mixing element from the exemplary sets of mixing elements depicted in FIG. 2.

FIG. 4 is a plan view of the sets of mixing elements of FIG. 2 depicted in a channel with the cover removed to expose the sets of mixing elements.

FIG. 5 is an enlarged cross-sectional view of mixing structure of FIG. 4 taken along line 5-5 in FIG. 4.

FIG. 6 is a side elevational view of an alternative set of mixing elements in a channel.

FIG. 7 is a plan view of another exemplary set of mixing elements depicted in a channel with the cover removed to expose the sets of mixing elements.

FIG. 8 is a perspective view of a portion of another pair of sets of mixing elements that may be used in a mixer according to the present invention.

FIG. 9 is an exploded perspective view of another exemplary mixing body that may be used in connection with the present invention.

FIG. 10 is an exploded perspective view of another exemplary mixing body that may be used in connection with the present invention.

FIG. 11 is a perspective view of a curved body containing a static mixer according to the present invention.

FIG. 12 depicts one exemplary fluid system including two static mixers according to the present invention.

### DETAILED DESCRIPTION OF EXEMPLARY EMBODIMENTS

In the following detailed description of illustrative embodiments of the invention, reference is made to the accompanying figures of the drawing which form a part hereof, and in which are shown, by way of illustration, specific embodiments in which the invention may be practiced. It is to be understood that other embodiments may be utilized and structural changes may be made without departing from the scope of the present invention.

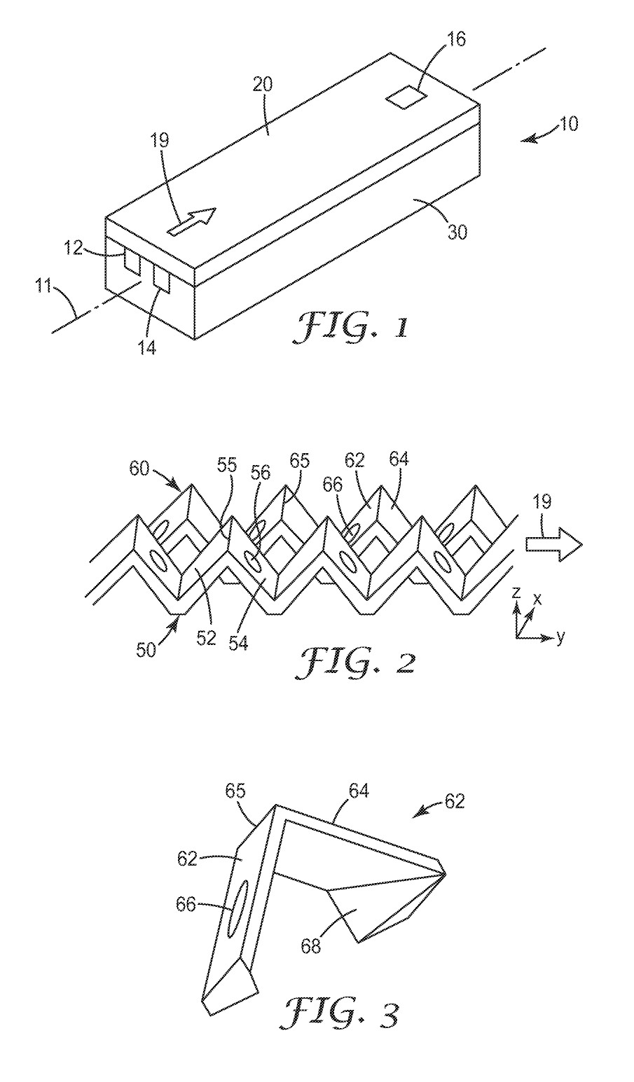

A mixer body 10 containing one exemplary static mixer is depicted in the perspective view of FIG. 1. As depicted in FIG. 1, the body 10 may preferably be in the form of a multilayer structure including two or more layers that provide a cover 20 and a base 30.

The mixer body 10 preferably includes one or more inlets, with the depicted body 10 including a first inlet 12 and a second inlet 14, both of which preferably open into the static mixer located in the body 10. The static mixer in body 10 also preferably includes one or more outlets through which fluids exit the static mixer formed in the mixer body 10, with the body 10 including one outlet 16. The body 10 preferably defines a channel through which fluids flow from the inlets 12 and 14 to the outlet 16. Although the static mixer in body 10 includes a pair of inlets 12 & 14 and one outlet 16, the static mixer may (in some embodiments) include only a single inlet and/or one or more outlets.

The inlets 12 & 14 and outlet 16 may define a downstream direction (generally aligned with the longitudinal axis 11) along which fluids passing through the channel in the static mixer move. In the view of FIG. 1, the downstream flow direction is represented by arrow 19. In other words, the fluids being mixed in the static mixer in body 10 may enter through the one or more inlets 12 & 14 and, after mixing, exit the static mixer through the outlet 16. In between the inlets 12 & 14 and the outlet 16, the fluids may preferably move in a downstream direction 19 that is generally aligned with the longitudinal axis 11 extending through the body 10.

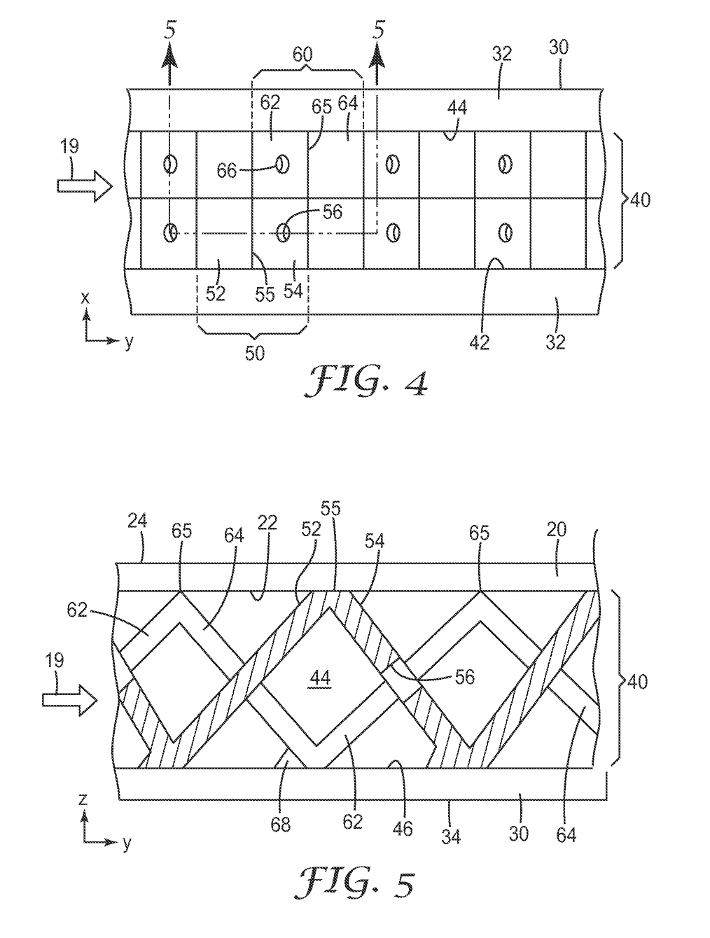

The channel formed in the body 10 may preferably includes two or more sets of mixing elements that are provided to mix fluids passing through the channel by forcing the fluids to change directions while advancing through the channel in the downstream direction. The mixing elements themselves preferably are not driven, but are preferably stationary within the channel. FIG. 2 is a perspective view of one exemplary pair of sets of mixing elements, FIG. 3 is a perspective view of one of the mixing elements within a set, FIG. 4 is a plan view of the sets of mixing elements 50 and 60 located in a channel 40, and FIG. 5 is a cross-sectional view of the channel 40 and mixing elements contained therein taken along line 5-5 in FIG. 4. This exemplary embodiment will be described with reference to FIGS. 1-5.

As depicted, the mixing elements are arranged in a set of first mixing elements 50 and a set of adjacent second mixing elements 60. Within each set of mixing elements, it may be preferred that the mixing elements are concatenated to form a unitary connected set of mixing elements.

In some embodiments, it may be preferred that the channel 40 in which the sets of mixing elements 50 and 60 are located is formed in the cover 20 or the base 30, with the opposing component enclosing the channel within the body 10 of the mixer. In the mixer of FIGS. 1-5, the channel 40 is formed in the base 30. The cover 20 is removed in the plan view of FIG. 4 to expose the sets of mixing elements 50 and 60 in the channel 40 formed in the base 30.

With reference to FIGS. 4 and 5, the cover 20 includes an interior surface 22 facing the channel 40 and an exterior surface 24 facing away from the channel 40. The base 30 includes the channel 40 formed therein. The channel 40 includes a first edge 42 and a second edge 44 that extend along the length of the channel 40 on opposites sides of the channel 40. In between the first and second edges 42 and 44, the channel 40 includes a bottom surface 46. As depicted in FIG. 5, the side edge 44 extends between the bottom surface 46 and the interior surface 22 of the cover 20. The base 30 includes an interior surface 32 that faces the interior surface 22 of the cover 20 and an exterior surface 34 that faces away from the cover 20.

The cover 20 and the base 30 may be attached to each other by any suitable technique or combination of techniques. Examples of some potentially suitable techniques may include, but are not limited to: thermal bonding, chemical welding, ultrasonic bonding, adhesive bonding (e.g., adhesive layer roll coated mixing structure substrate, adhesive sheet transfer from a backing roll (which may include a post operation for opening any obstructed holes)), etc.

The channel 40 may preferably take a generally straight path, with fluid flow passing through the channel 40 in the downstream direction indicated by arrow 19, although at any particular location in the channel 40 fluid may be moving in any of three dimensions occupied by the channel 40 (i.e., length, width and/or height). Each of FIGS. 2, 4, and 5 are provided with reference axes x, y, and/or z to assist in describing the mixer. As oriented, they axis will generally be aligned with the downstream direction through the channel 40, the x axis will be oriented generally transverse to the downstream direction (the y axis) such that the x axis can be described as extending across the width of the channel 40. The height can be represented by the z axis which is oriented generally transverse to both the length of the channel (they axis) and the width of the channel (the x axis).

As described herein, the channel 40 includes two sets of mixing elements 50 and 60 that define offset paths through the channel 40. Although the channel 40 includes only two sets of mixing elements, in some embodiments the channels may contain three or more sets of mixing elements arranged across the width of the channels. The mixing elements 50 and 60 within the different sets are preferably, but not necessarily the same structures. The mixing elements 50 and 60 are preferably concatenated and arranged sequentially along the length of the channel 40 within each of the sets. It may also be preferred that the adjacent sets of mixing elements 50 and 60 are offset from each other along the length of the channel 40 such that the second intermediate locations 65 of the set of second mixing elements 60 are positioned downstream from the first intermediate locations 55 of the set of first mixing elements 50 when moving through the channel 50 in the downstream direction indicated by arrow 19.

With respect to the mixing elements 50 in the first set of mixing elements, each of the mixing elements 50 includes an upstream panel 52 and a downstream panel 54, with the upstream and downstream directions being indicated by the downstream fluid flow 19 through the mixing elements 50. Each mixing element 50 defines a first mixing element length that extends from an upstream end of the first mixing element 50 to a downstream end of the first mixing element 50, with the upstream end being found at the upstream end of the upstream panel 52 and the downstream end being found at the downstream end of the downstream panel 54.

The upstream panel 52 of the mixing element 50 preferably extends from the bottom surface 46 of the channel 40 at the upstream end of the first mixing element 50 to the top surface 22 of the channel 40 at a first intermediate location 55 that is between the downstream end and the upstream end of the first mixing element 50.

The downstream panel 54 of the mixing element 50 preferably extends from the top surface 22 of the channel 40 to the bottom surface 46 of the channel 40, where the downstream panel 54 meets the bottom surface 46 of the channel 40 at the downstream end of the first mixing element 50. The downstream panel 54 preferably extends from the top surface 22 of the channel 40 at the first intermediate location 55 where the upstream panel 52 meets the top surface 22 (or alternately at a location downstream of the first intermediate location 55 as described in connection with another embodiment).

The downstream panel 54 of the mixing element 50 preferably includes an opening 56 formed therethrough. It may be preferred that at least a portion of the fluid in the volume defined by the bottom surface 46 of the channel 40, the upstream panel 52 and the downstream panel 54 can pass through the opening 56 in the downstream panel 54 such that it enters the volume defined by the top surface 22 of the channel 40, the downstream panel 54 containing the opening through which the fluid just passed and the upstream panel 52 of the next mixing element 50. Although not required, it may be preferred that the openings 56 in the downstream panels 54 be centered within the panels 54.

While the opening 56 in FIGS. 2, 4 and 5 is shown as a circle, the opening 56 may be any geometric shape. For example, the opening 56 may be elliptical, curvilinear, square, etc.

The portion of the fluid located within the volume defined by the bottom surface 46 of the channel 40, the upstream panel 52 and the downstream panel 54 that does not pass through the opening 56 is preferably redirected across the width of the channel 40 into the volume occupied by the adjacent set of mixing elements 60 because of the offset arrangement of the mixing elements 50 and 60.

The adjacent set of mixing elements 60 also include upstream panels 62 and downstream panels 64. Each mixing element 60 defines a second mixing element length that extends from an upstream end of the second mixing element 60 to a downstream end of the second mixing element 60, with the upstream end being found at the upstream end of the upstream panel 62 and the downstream end being found at the downstream end of the downstream panel 64.

The upstream panel 62 of the mixing element 60 preferably extends from bottom surface 46 of the channel 40 at the upstream end of the second mixing element 60 to the top surface 22 of the channel 40 at a second intermediate location 65 that is between the downstream end and the upstream end of the second mixing element 60.

The downstream panel 64 of the mixing element 60 preferably extends from the top surface 22 of the channel 40 to the bottom surface 46 of the channel 40, where the downstream panel 64 meets the bottom surface 46 of the channel 40 at the downstream end of the second mixing element 60. The downstream panel 64 preferably extends from the top surface 22 of the channel 40 at the second intermediate location 65 where the upstream panel 62 meets the top surface 22 (or alternately at a location downstream of the second intermediate location 65 as described in connection with another embodiment).

The upstream panel 62 of the mixing element 60 preferably includes an opening 66 formed therethrough. It may be preferred that at least a portion of the fluid in the volume defined by the top surface 22 of the channel 40, the upstream panel 62 and the downstream panel 64 of the mixing element 60 located upstream of the panel 62 can pass through the opening 66 in the upstream panel 62 such that it enters the volume defined by the bottom surface 46 of the channel 40, the upstream panel 62 and the downstream panel 64 of the mixing element 60. Although not required, it may be preferred that the openings 66 in the upstream panels 62 be centered within the panels 62.

While the opening 66 in FIGS. 2-4 is shown as a circle, the opening 56 may be any geometric shape. For example, the opening 56 may be elliptical, curvilinear, square, etc.

The portion of the fluid located within the volume defined by the top surface 22 of the channel 40, the upstream panel 62 and the downstream panel 64 of the mixing element 60 located upstream of the panel 62 that does not pass through the opening 66 in the upstream panel 62 is preferably redirected across the width of the channel 40 into the volume occupied by the adjacent set of mixing elements 50 because of the offset arrangement of the mixing elements 50 and 60.

The offset arrangement of mixing elements 50 and 60, along with their respective openings 56 and 66, causes some fluid to move through each mixing element along the length of the channel 40 (i.e., along the y-axis) while the remainder of the fluid moves in the directions represented by the x and z axes as well as in the downstream direction represented by they axis. The net result is preferably efficient and thorough mixing of the fluid as it passes through the channel 40.

Among the features depicted in FIGS. 2-5, it may be preferred that, for each of the first mixing elements 50, the downstream panel 54 extends from the top surface 22 of the channel 40 at the first intermediate location 55 where the upstream panel 52 meets the top surface. With respect to each of the second mixing elements 60, the downstream panel 64 may preferably extend from the top surface 22 of the channel 44 at the second intermediate location 65 where the upstream panel 62 meets the top surface 22 of the channel 40.

For each of the first mixing elements 50 located between an upstream first mixing element 50 and a downstream first mixing element 50 (i.e. for a mixing element 50 that is located within the interior of the concatenated set of mixing elements 50), the upstream panel 52 may preferably extend from the bottom surface 46 of the channel 40 where the downstream panel 54 of the upstream mixing element 50 meets the bottom surface 46 of the channel 40 (where the upstream mixing element 50 is the mixing element that is located just upstream of the upstream panel 52 of the mixing element of interest). In other words, it may be preferred that each of the concatenated mixing elements 50 be located immediately adjacent to the upstream mixing element 50.

For each of the second mixing elements 60 located between an upstream second mixing element 60 and a downstream second mixing element 60 (i.e. for a mixing element 60 that is located within the interior of the concatenated set of mixing elements 60), the upstream panel 62 extends from the bottom surface 46 of the channel 40 where the downstream panel 64 of the upstream second mixing element 60 meets the bottom surface 46 of the channel 40 (where the upstream mixing element 60 is the mixing element located just upstream of the upstream panel 62 of the mixing element of interest). In other words, it may be preferred that each of the concatenated mixing elements 60 be located immediately adjacent to the downstream mixing element 60 in the set.

For each of the second mixing elements 60, it may be preferred that the downstream panel 64 extends from the top surface 22 of the channel 40 at the second intermediate location 65 where the upstream panel 62 meets the top surface 22 of the channel 40.

As discussed herein, it may be preferred that the adjacent sets of mixing elements 50 and 60 be offset from each other along the length of the channel 40. For example, it may be preferred that the downstream panels 54 of most of the first mixing elements 50 are aligned with the upstream panels 62 of the second mixing elements 60 across the width of the channel 40 (where the width is along the x-axis in FIGS. 2 and 4).

Another manner in which the offset between adjacent sets of mixing elements 50 and 60 may be described is that, as depicted in FIGS. 4 and 5, the sets of mixing elements 50 and 60 are offset from each other along the length of the channel 40 such that the upstream ends of most of the first mixing elements 50 are aligned with the second intermediate locations 65 of the second mixing elements 60 across the width of the channel 60.

Referring to FIGS. 3 and 5, the mixing elements may be provided with flow diverters to reduce the likelihood that fluid moving through the mixing structures in the downstream direction pools or otherwise becomes trapped within the structure itself. One example of such a flow diverter 68 is seen in FIG. 3 and also in FIG. 5. The flow diverter 68 may preferably have a triangular prismatic shape to assist in moving fluid back towards the junction between the mixing elements 60 and the mixing elements 50 to further enhance mixing performance, although other shapes could also be used. Mixing elements 50 may also include flow diverters 58 as seen in the cross-sectional view of FIG. 5. The flow diverters preferably occupy the crevices that could otherwise trap fluids at the junctions between the downstream panels 54 and 64 and the bottom surface 46 of the channel 40.

It may be preferred that the widths of the mixing elements 50 and 60 be substantially equal, although in some embodiments the sets of mixing elements 50 and 60 may have different widths across the width of the channel 40. Also, although it may be preferred that the mixing elements within each concatenated set have a uniform width, the widths of the mixing elements within a set may vary.

Other features depicted in connection with the embodiment of FIGS. 2-5 are that the mixing element lengths are uniform within each set of concatenated mixing elements and that the mixing element lengths between the two sets are also equal (i.e., mixing elements 50 have the same length as mixing elements 60) although these relationships are not required.

Still other features that are depicted in connection with the embodiment of FIGS. 2-5 are that the upstream panels 52 and the downstream panels 54 of the set of first mixing elements 50 are flat structures. Similarly, the upstream panels 62 and the downstream panels 64 of the set of second mixing elements 60 are also flat structures. It should, however, be understood that the panels making up the mixing elements may or may not be flat.

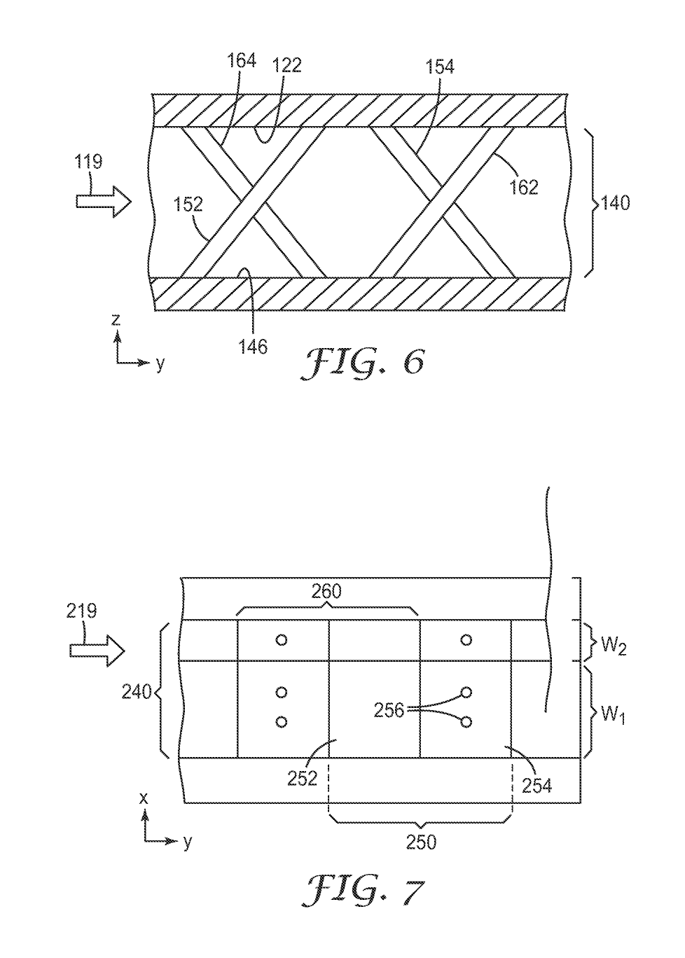

Another embodiment of a mixer is depicted in the side view of FIG. 6 which is essentially a view of the channel 140 with one side removed to expose the mixing elements contained therein. The channel 140 includes a concatenated set of first mixing elements that include an upstream panel 152 and a downstream panel 154. The upstream panel 152 extends from the bottom surface 146 to the top surface 122 of the channel 140, with the panel 152 being canted in the downstream direction (as indicated by flow arrow 119). The downstream panel 154 extends from the top surface 122 to the bottom surface 146 of the channel 140, with the panel 154 also being canted such that the panel 154 meets the bottom surface 146 at a location downstream of the location at which the panel 154 meets the top surface 122 of the channel 140.

Also seen in FIG. 6 is the adjacent set of concatenated mixing elements that is located behind the first set of mixing elements in the view of FIG. 6. The mixing elements of the second set include an upstream panel 162 and a downstream panel 164 (although it should be noted that the downstream panel 164 and the upstream panel 162 seen in FIG. 6 are from different mixing elements).

Differences between the mixing elements as depicted in FIG. 6 and those in the channel 40 of FIGS. 2-5 is that, within each mixing element, the upstream and downstream panels do not meet at the same location on the upper surface 122 of the channel. Also, the mixing elements are not immediately adjacent each other such that, e.g., the upstream panel 152 of the successive downstream mixing element does not meet the downstream panel 154 of the preceding upstream mixing element.

Another exemplary embodiment of a mixer according to the present invention is depicted in the plan view of FIG. 7 where the cover of the channel 240 has been removed to expose the mixing elements located therein. Fluid preferably moves through the channel 240 in the direction of flow arrow 219. The adjacent sets of concatenated mixing elements 250 and 260 depict a number of differences from the embodiment depicted and described in connection with FIGS. 2-5.

For example, the downstream panels 254 of the mixing elements 250 include two openings 256 formed therethrough rather than the single opening 56 depicted in panels 54. In some embodiments, it may be preferred to include only a single opening as seen In FIGS. 2, 4, and 5, while in other embodiments, a single panel may include two or more openings formed therethrough.

Another variation depicted in FIG. 7 is that the sets of concatenated mixing elements 250 and 260 do not have substantially equal widths (as measured along the x-axis). The mixing elements 250 have a width indicated by reference w₁ while the mixing elements 260 have a width indicated by reference w₂.

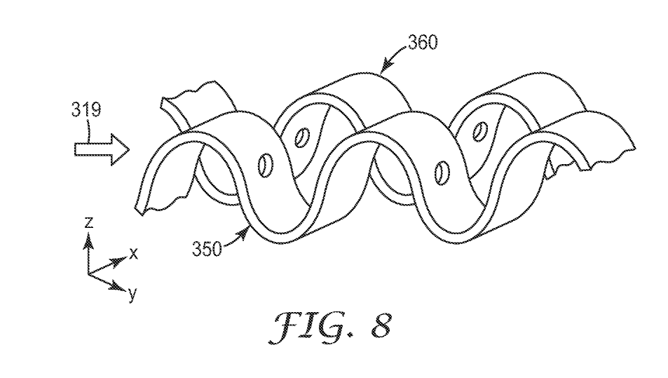

Still another set of variations in mixers according to the present invention can be described with reference to FIG. 8 in which two adjacent sets of concatenated mixing elements 350 and 360 are depicted (outside of a channel). Unlike the mixing elements described in connection with the embodiments of FIGS. 2-7, the mixing elements are constructed with curved panels instead of flat panels. It may be preferred that the curved panels follow a sinusoidal curve, although that is not required. The mixing elements 350 and 360 also preferably include openings in their downstream and upstream panels as discussed with the mixers described above. Also, although not shown, the mixing elements may include flow diverters as described above in connection with FIGS. 3 and 5 to reduce the likelihood that fluids will become trapped within the structures as they move in the downstream direction indicated by flow arrow 319.

Although the exemplary mixer structures depicted in FIGS. 2-8 may have straight channels, in some embodiments that channels may not be straight. For example, in some embodiments, the channels may be curved, e.g., serpentine, etc., to enhance mixing of fluids passing therethrough.

It may be preferred that the channels be formed entirely in the bases, with the covers being provided to form the top surfaces of the channels. A potential advantage to this construction is that the covers can be provided as flat, featureless articles (e.g., films, plates, etc.) that do not necessarily require precise alignment with the base. Alternatively, the channels may be partially formed into both the bases and the covers.

The components of the mixers of the present invention may be formed by any suitable technique, e.g., SMS-based vacuum/thermoformed female tooling, extrusion replication male tool embossing, chemical etching/lithography, two-photon polymerization, etc., and any combination of two or more thereof. Although the mixing elements may be formed integrally within the channels, they may alternatively be provided as separate components that are inserted into the channel to form the desired mixing structure.

It may be preferred in some embodiments that the mixing elements be formed as separate and discrete articles placed in the channels that are formed in the base and/or cover. The mixing elements may be loosely retained within the channel, although it may be preferred that the mixing elements be retained within the channel by compression between the sides of the channel and/or between the bottom and top surfaces of the cover. The mixing elements may also, in some embodiments, be retained in place within the channel by one or more other techniques (in addition to or in place of compression). Those other retention techniques may include, e.g., adhesives, thermal bonding, chemical welding, ultrasonic welding, etc.

The bases and covers in mixers of the present invention may be attached to each other by any suitable technique (or combination of techniques) that are capable of sealing the cover to the base such that fluids passing through the channel do not leak into the interface between the cover and the base. Examples of some potentially suitable techniques may include, but are not limited to: thermal bonding, chemical welding, ultrasonic bonding, adhesive bonding (e.g., adhesive layer roll coated mixing structure substrate, adhesive sheet transfer from a backing roll (which may include a post operation for opening any obstructed holes)), etc.

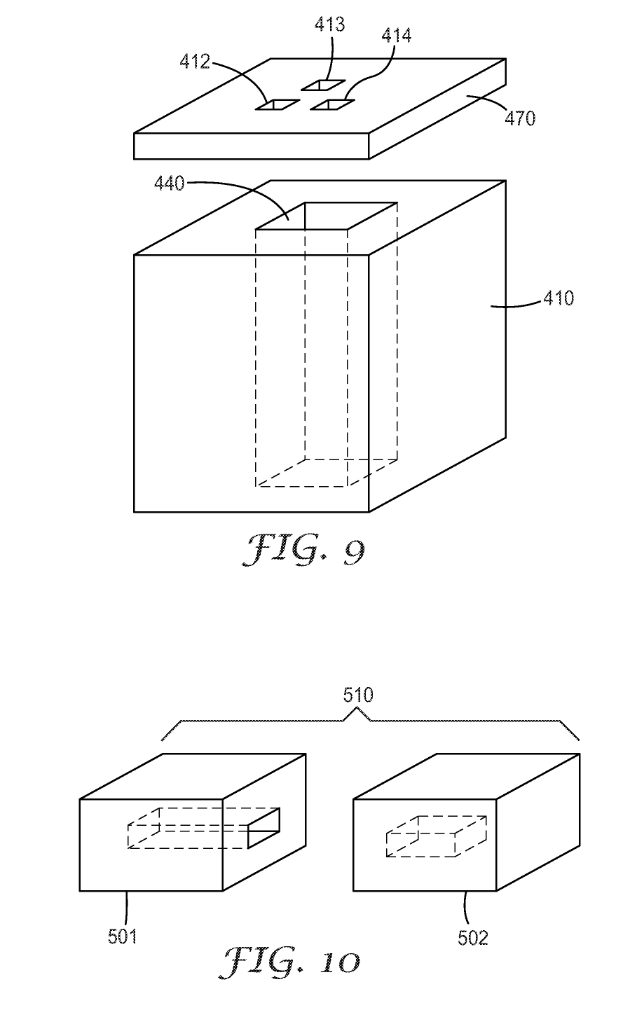

In still other embodiments, the channels may be formed in unitary bodies that are not in the form of a base and attached cover. Referring to FIG. 9, the body 410 may be in the form of a unitary article, with the mixing elements (not shown) inserted into one end of the channel 440. The open end of the channel 440 may then be closed by any suitable structure such as, e.g., end cap 470 which may include inlets 412, 413, and 414 to provide paths through the end cap 470 into the channel 440.

Yet another alternative construction is depicted in FIG. 10 in which a body 510 is split into two components 501 and 502, with the channel 540 being formed partially within each component 501 and 502.

Suitable material or materials used to manufacture the mixer components may include, e.g., polymers (polycarbonates, polypropylenes, polyethylenes, etc.), glasses, metals, ceramics, silicons, etc. The selection of materials may be made based on a variety of factors including, but not limited to, manufacturability, compatibility with the materials to be mixed, thermal properties, optical properties, etc.

Although depicted as a single channel in a single body, the mixers of the present invention may be provided in arrays of two or more channels that are arranged in any suitable configuration, parallel and/or sequentially, as needed to obtain the desired performance in terms of flow throughput, pressure drop, mixing efficiency, etc. For example, two or more separate and discrete channels may be used in parallel to provide two or more paths through a common mixer body. In another alternative, the channels may be stacked such that, e.g., the exterior surface 34 of one base 30 (see, e.g., FIG. 5) serves as the cover for a lower base, while the upper base includes its own channel. In some mixers channels may be provided in both common bases and in a stacked arrangement, such that a single mixer body may include an array of channels arranged in both x and z dimensions, where the channels define flowpaths that extend in the y dimension.

The dimensions of the mixers of the present invention may be selected to obtain the desired flow rates and volumes suitable for the materials to be mixed. In one exemplary embodiment manufactured of a cover 20 and a base 30 (as depicted in, e.g., FIGS. 1-5), the mixer body 10 may have dimensions of about 100 millimeters (mm) in length (measured in the flow direction), 10 mm in width, and 5 mm in height.

The mixers of the present invention may also, or alternatively, be characterized in terms of channel length as measured by the shortest line that travels along the fluid flowpath from the input to the outlet. For example, the channel may be described as having a channel length of 100 mm or less, 50 mm or less, or even 10 mm or less, etc.

Other exemplary dimensions that may be used to characterize the mixers of the present invention may include variations in the height, width, or open cross-sectional area of the channels. For example, as measured in a plane oriented orthogonal to the downstream direction of flow through the channel, the channel may have a maximum height between the top surface and the bottom surface of, e.g., 250 micrometers or less, 100 micrometers or less, etc. In another example, the channel, as measured in a plane oriented orthogonal to the downstream direction of flow through the channel, may have a maximum width between the first edge and the second edge of, e.g., 1000 micrometers or less, 500 micrometers or less, etc.

In still another example, the open cross-sectional area of the channel, as measured in a plane oriented orthogonal to the downstream direction of flow through the channel, may have a maximum open cross-sectional area of, e.g., 250,000 square micrometers or less, 62500 square micrometers or less, etc.

In yet another example, the channel in a mixer of the present invention may have, as measured in a plane oriented orthogonal to the downstream direction of flow through the channel, may have a maximum width between the first edge and the second edge and a maximum height between the top surface and the bottom surface, wherein the ratio of the maximum width to the maximum height may be 1 or more, 2 or more, etc. In some embodiments, the ratio of the maximum width to the maximum height of the channel may be 2 or more and 4 or less.

In certain embodiments, the mixers of the present invention may include variations in the height, width, or open cross-sectional area of the channels that are macro in size. For example, the open cross-sectional area of the channel, as measured in a plane oriented orthogonal to the downstream direction of flow through the channel, may have a maximum open cross-sectional area of, e.g., 25 square millimeters or less, 12.5 square millimeters or less, etc.

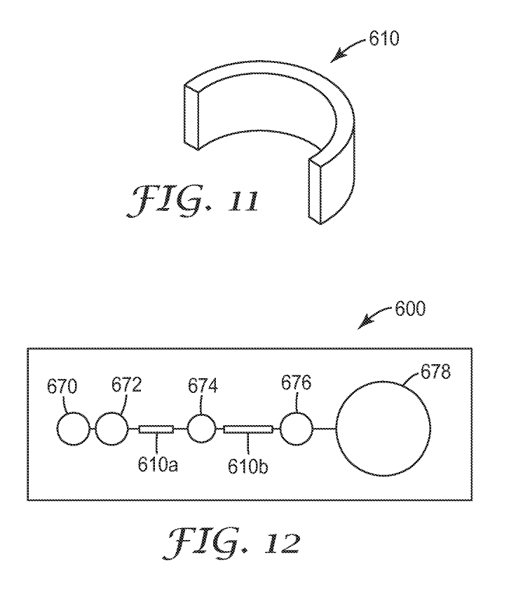

Although the bodies containing one or more mixers according to the present invention are generally flat and the downstream direction of flow defined by the mixing structure may be described as following a straight linear path, the mixing structures of the invention may alternatively be located within a curved body 610 as depicted in, e.g., FIG. 11. If the body containing the mixing structure is curved, the downstream direction of flow defined by the mixing structure may be described as following a curvilinear path through the body.

The bodies containing static mixers of the present invention may be rigid or flexible (where a flexible body may be manipulated between flat or non-flat (i.e., curved) without significant permanent deformation of the body and without destroying the integrity of the channels in the mixing structure). For example, in some embodiments, a body containing one or more of the static mixers of the present invention may be manipulated into a curved shape during use to assist in processing, reduce the volume needed for the mixer, etc.

Although the static mixers may be used in many different fluid applications, it may be preferred that the static mixers of the present invention be used in fluid systems that incorporate one or more of the static mixers.

FIG. 12 depicts one exemplary integrated fluid system 600 that is integrated into one unitary body 602 and that incorporates at least one static mixer according to the present invention and channels that can be used to fluidly connect the different features in the system 600. The depicted fluid system 600 includes two chambers 670 & 672 that feed into one mixer 610a provided in the fluid system 600. The mixer 610a may preferably, but not necessarily, be a static mixer constructed according to the present invention. Although two chambers 670 & 672 are included in the fluid system 600, other fluid systems 600 may include only one such chamber or more than two chambers that feed into the mixer 610a. In the depicted embodiment, the chambers may be used to introduce one or more samples and one or more reagents into the mixer 610a. In some embodiments, one of the chambers may be dedicated to introducing samples to the mixer 610a while the other chamber may be used to introduce one or more reagents into the mixer (although in some fluid systems, samples may be premixed or loaded with one or more reagents, carrier fluids, etc. into one or both of the chambers).

After passing through the first mixer 610a, the mixed fluid may be collected in an intermediate chamber 674 located downstream of the mixer 610a. The intermediate chamber 674 may, in some embodiments, contain one or more reagents that may be contacted by the mixed fluid entering the intermediate chamber 674. That contact may preferably result in at least some of the one or more reagents in the intermediate chamber 674 being taken up into the mixed fluid.

The fluid system 600 of FIG. 12 also includes a second mixer 610b located downstream of the intermediate chamber 674. The second mixer 610b may, for example, be used to mix one or more reagents taken up in the intermediate chamber 674 with the mixed fluid that was delivered into the intermediate chamber 674 from the first mixer 610a. The second mixer 610b may be of the same design as the first mixer 610a or it may be of a different design. In some fluid systems, both mixers 610a and 610b may be constructed according to the present invention, while in other fluid systems only one of the mixers may be manufactured according to the principles of the present invention.

The fluids that exit the second mixer 610b may be delivered into another chamber 676 located downstream from the second mixer 610b in the fluid system 600. It may be preferred that the chamber 676 contain one or more additional reagents that may be combined with the mixed fluid exiting the second mixer 610b. In some embodiments, for example, the chamber 676 may include one or more reagents that assist in detection of one or more analytes within the mixed fluid delivered into the chamber 676.

The fluid system 600 depicted in FIG. 12 may also preferably include a collection chamber 678 located downstream of the chamber 676. The collection chamber 678 may be used as, e.g., a waste chamber to collect materials from the chamber 676.

Fluid movement through the various features in the fluid system 600 may be supplied using any suitable technique or techniques through one or more channels extending between the different features in the system 600. For example, fluid movement may be driven by gravity, capillary forces, centrifugal forces (if, e.g., the fluid system 600 is rotated), etc. In some instances, the fluid system 600 may include one or more pumps that may function to either drive fluid through the various features using positive pressure or, alternatively, to pull fluids through the structures using negative pressure (e.g., vacuum) developed downstream of the feature or features through which fluid is to be pulled. The pumps may include a power source (e.g., a battery, etc.) or the pumps used in connection with the present invention may be manually powered. Examples of some other potentially suitable manually powered pumps may include, e.g., devices that include resilient cavities that can be compressed and, when returning to their pre-compression states, provide a vacuum force at the inlet of the pump (e.g., bulbs, hemovacs, etc.).

Although not depicted in FIG. 12, the fluid system 600 may also include one or more fluid control features such as valves to control the flow through the various features. For example, it may be preferred that any fluids introduced into the chambers 670 and 672 upstream of the first static mixer 610a be held in the chambers until the fluids are ready to be simultaneously introduced into the mixer 610a. The valves may include physical structures (e.g., sacrificial membranes, ball valves, gate valves, etc.) that are physically opened or they may be fluidic features capable of providing fluid flow control (e.g., capillary valves that prevent fluid flow using, e.g., surface tension, etc.).

### Applications of Static Mixers

In one application, the mixer can be used as a component of a device that can perform an immunoassay, such as a lateral flow immunoassay. One or more mixers can be molded in a substrate that also provides molded features to hold reagents for an assay.

In one embodiment, the device could have a molded chamber upstream of the mixer to hold a binding agent, such as a conjugate antibody, and a molded feature downstream of the mixer, which provides a defined location where a capture agent, such as a capture antibody, can be immobilized.

Alternatively, the device could be designed with molded features that allow inserts upstream and/or downstream of the mixer. The inserts would consist of a substrate functionalized with a binding agent, such as conjugate and/or a capture antibody. Appropriate substrates used as inserts could include filter membranes such as nylon, nitrocellulose, PTFE, PVDF, polysulphone; or films such as polypropylene, polyester, polyethylene, and polycarbonate. Binding agents, such as capture and/or conjugate antibodies, may be immobilized on these membranes or film inserts using coating processes typically used for nitrocellulose-based immunoassays, such as those processes described by BioDot, Inc (Irvine, Calif.).

The device can also include molded features to allow for collection and containment of waste fluid downstream of the capture zone. A molded feature for this purpose could be a reservoir filled with a cellulose wicking material in capillary contact with the microfluidic system capable of holding a volume of fluid between 10 and 1000 uL. The wicking material can be chosen to have specific physical properties (i.e. porosity) that will allow not only containment of the waste fluid, but control of the capillary flow rates in the microfluidic device.

The device described above would be used in a manner similar to a lateral flow immunoassay. A given analyte can be introduced in the inlet port of the device upstream of the chamber containing the binding agent, such as conjugate antibody. The analyte-containing fluid then passes through or over the binding agent (e.g., conjugate antibody), allowing the binding agent to diffuse into the fluid stream. The fluid stream can pass through the static mixer as described herein which will facilitate for conjugation of the binding agent to the target analyte. Once mixed, the fluid containing the binding agent/target analyte complex can pass through or over the capture zone where the binding agent/target analyte complex will be captured by another binding agent, e.g., the immobilized capture antibody, thus forming the final immunoassay sandwich. Finally, the remaining fluid stream can enter and collect in the waste chamber. An optional readout determining the presence or absence of a complete immunoassay-sandwich could be based on visual or instrument-based detection, depending on the choice of labels used for the binding agents.

In a second embodiment, the device described above could incorporate parallel fluidic paths on a single molded substrate to allow for the simultaneous detection of multiple analyte targets or to allow the inclusion of control tests. Each fluidic path could contain one or more of the static mixers described herein. The fluidic paths could feed from a single inlet or multiple inlets, depending on the requirements of the immunoassay of interest.

In another embodiment, the device could also include molded features upstream of the chamber for the binding agent, for example a conjugate antibody, to allow for incorporation of a sample preparation. For example, a chamber holding a lysing agent or other chemical treatments, could be incorporated upstream of the of the binding agent in order to liberate analytes, such as protein targets from a cell, that would otherwise not be accessible to the binding agent.

In some cases, it may be advantageous to include one or more mixer elements between a sample preparation chamber and the binding agent's location to increase the efficiency of the sample treatment (e.g., lysis efficiency). In other cases, the sample preparation may use paramagnetic beads to isolate and concentrate a sample. It may be possible to mold features in the device that will hold these types of beads as well as the magnets necessary to effect the separations when necessary along the flow path. Another possibility may be to include molded features that will incorporate filtration elements based on size exclusion to prepare the sample.

The complete disclosure of the patents, patent documents, and publications cited in the Background, the Detailed Description of Exemplary Embodiments, and elsewhere herein are incorporated by reference in their entirety as if each were individually incorporated.

Exemplary embodiments of this invention are discussed and reference has been made to possible variations within the scope of this invention. These and other variations and modifications in the invention will be apparent to those skilled in the art without departing from the scope of the invention, and it should be understood that this invention is not limited to the exemplary embodiments set forth herein. Accordingly, the invention is to be limited only by the claims provided below and equivalents thereof.

1. A static mixer comprising a mixing structure formed within a body, wherein the mixing structure further comprises:
a channel comprising a bottom surface and a top surface, wherein fluid flowing through the channel defines a flowpath comprising a downstream direction through the channel from an inlet where the fluid enters the channel to an outlet where the fluid exits the channel, and wherein the channel comprises a length from the inlet to the outlet, a width oriented generally transverse to the length, and a height oriented generally transverse to both the length and the width;
a set of first mixing elements arranged sequentially along the length of the channel, wherein each first mixing element comprises a first mixing element length that extends from an upstream end of the first mixing element to a downstream end of the first mixing element, and wherein each first mixing element further comprises:
an upstream panel extending from the bottom surface of the channel at the upstream end of the first mixing element to the top surface of the channel at a first intermediate location that is between the downstream end and the upstream end of the first mixing element;
a downstream panel extending from the top surface of the channel to the bottom surface of the channel, wherein the downstream panel meets the bottom surface of the channel at the downstream end of the first mixing element, and wherein the downstream panel extends from the top surface of the channel at the first intermediate location where the upstream panel meets the top surface or downstream thereof;
one or more openings formed through the downstream panel, wherein fluid can flow through the opening in the downstream panel;
a set of second mixing elements arranged sequentially along the length of the channel, wherein each second mixing element comprises a second mixing element length that extends from an upstream end of the second mixing element to a downstream end of the second mixing element, and wherein each second mixing element further comprises:
an upstream panel extending from the bottom surface of the channel at the upstream end of the second mixing element to the top surface of the channel at a second intermediate location that is between the downstream end and the upstream end of the second mixing element;
a downstream panel extending from the top surface of the channel to the bottom surface of the channel, wherein the downstream panel meets the bottom surface of the channel at the downstream end of the second mixing element, and wherein the downstream panel extends from the top surface of the channel at the second intermediate location where the upstream panel meets the top surface or downstream thereof;
one or more openings formed through the upstream panel of the second mixing element, wherein fluid can flow through the opening in the upstream panel;
wherein the set of first mixing elements and the set of second mixing elements are arranged side-by-side across the width of the channel;
and wherein the set of first mixing elements and the set of second mixing elements are offset from each other along the length of the channel such that the second intermediate locations of the set of second mixing elements are positioned downstream from the first intermediate locations of the set of first mixing elements when moving through the channel in the downstream direction.

2. A static mixer according to claim 1, wherein, for each of the first mixing elements, the downstream panel extends from the top surface of the channel at the first intermediate location where the upstream panel meets the top surface.

3. A static mixer according to claim 1, wherein, for each of the second mixing elements, the downstream panel extends from the top surface of the channel at the second intermediate location where the upstream panel meets the top surface.

4. A static mixer according to claim 1, wherein, for each of the first mixing elements, the downstream panel extends from the top surface of the channel at the first intermediate location where the upstream panel meets the top surface; and wherein, for each of the second mixing elements, the downstream panel extends from the top surface of the channel at the second intermediate location where the upstream panel meets the top surface.

5. A static mixer according to claim 1, wherein, for each of the first mixing elements located between an upstream first mixing element and a downstream first mixing element, the upstream panel extends from the bottom surface of the channel where the downstream panel of the upstream first mixing element meets the bottom surface.

6. A static mixer according to claim 1, wherein, for each of the second mixing elements located between an upstream second mixing element and a downstream second mixing element, the upstream panel extends from the bottom surface of the channel where the downstream panel of the upstream second mixing element meets the bottom surface.

7. A static mixer according to claim 1, wherein, for each of the second mixing elements, the downstream panel extends from the top surface of the channel at the second intermediate location where the upstream panel meets the top surface.

8. A static mixer according to claim 1, wherein the set of first mixing elements and the set of second mixing elements are offset from each other along the length of the channel such that the downstream panels of most of the first mixing elements are aligned with the upstream panels of the second mixing elements across the width of the channel.

9. A static mixer according to claim 1, wherein the set of first mixing elements and the set of second mixing elements are offset from each other along the length of the channel such that the upstream ends of most of the first mixing elements are aligned with the second intermediate locations of the second mixing elements across the width of the channel.

10. A static mixer according to claim 1, wherein the set of first mixing elements occupy a first width across the width of the channel, and wherein the set of second mixing elements occupy a second width across the width of the channel, and further wherein the first width and the second width are substantially equal.

11. A static mixer according to claim 1, wherein the set of first mixing elements occupy a first width across the width of the channel, and wherein the set of second mixing elements occupy a second width across the width of the channel, and further wherein the first width and the second width are different.

12. A static mixer according to claim 1, wherein the first mixing element lengths of the set of first mixing elements are uniform.

13. A static mixer according to claim 1, wherein the second mixing element lengths of the set of second mixing elements are uniform.

14. A static mixer according to claim 1, wherein the first mixing element lengths of the set of first mixing elements are uniform, and wherein the second mixing element lengths of the set of second mixing elements are uniform.

15. A static mixer according to claim 14, wherein the uniform first mixing element lengths are substantially equal to the uniform second mixing element lengths.

16. A static mixer according to claim 1, wherein the upstream panels and the downstream panels of the set of first mixing elements are flat structures.

17. A static mixer according to claim 1, wherein the upstream panels and the downstream panels of the set of second mixing elements are flat structures.

18. A static mixer according to claim 1, wherein the upstream panels and the downstream panels of the set of first mixing elements are flat structures, and wherein the upstream panels and the downstream panels of the set of second mixing elements are flat structures.

19. A static mixer according to claim 1, wherein the upstream panels and the downstream panels of the set of first mixing elements are curved structures.

20. A static mixer according to claim 1, wherein the upstream panels and the downstream panels of the set of second mixing elements are curved structures.

21. A static mixer according to claim 1, wherein the upstream panels and the downstream panels of the set of first mixing elements are curved structures, and wherein the upstream panels and the downstream panels of the set of second mixing elements are curved structures.

22. A static mixer according to claim 1, wherein the downstream panel of each of the first mixing elements includes only one opening formed therethrough.

23. A static mixer according to claim 1, wherein the upstream panel of each of the second mixing elements includes only one opening formed therethrough.

24. A static mixer according to claim 1, wherein the downstream panel of each of the first mixing elements includes only one opening formed therethrough, and wherein upstream panel of each of the second mixing elements includes only one opening formed therethrough.

25. A static mixer according to claim 1, wherein the openings in the downstream panels of the first mixing elements are centered in the downstream panels.

26. A static mixer according to claim 1, wherein the openings in the upstream panels of the second mixing elements are centered in the upstream panels.

27. A static mixer according to claim 1, wherein the openings in the downstream panels of the first mixing elements are centered in the downstream panels, and wherein the openings in the upstream panels of the second mixing elements are centered in the upstream panels.

28. A static mixer according to claim 1, wherein, in a plane oriented orthogonal to the downstream direction of the static mixer, the channel comprises a maximum height between the top surface and the bottom surface of 250 micrometers or less.

29. A static mixer according to claim 1, wherein, in a plane oriented orthogonal to the downstream direction of the static mixer, the channel comprises a maximum width between the first edge and the second edge of 1000 micrometers or less.

30. A static mixer according to claim 1, wherein, in a plane oriented orthogonal to the downstream direction of the static mixer, the channel comprises a maximum open cross-sectional area of 250000 square micrometers or less.

31. A static mixer according to claim 1, wherein, in a plane oriented orthogonal to the downstream direction of the static mixer, the channel comprises a maximum width between the first edge and the second edge and a maximum height between the top surface and the bottom surface, and further wherein a ratio of the maximum width to the maximum height is 1 or more.

32. A static mixer according to claim 1, wherein, in a plane oriented orthogonal to the downstream direction of the static mixer, the channel comprises a maximum width between the first edge and the second edge and a maximum height between the top surface and the bottom surface, and further wherein a ratio of the maximum width to the maximum height is 2 or more.

33. A static mixer according to claim 1, wherein, in a plane oriented orthogonal to the downstream direction of the static mixer, the channel comprises a maximum width between the first edge and the second edge and a maximum height between the top surface and the bottom surface, and further wherein a ratio of the maximum width to the maximum height is 2 or more and 4 or less.

34. A static mixer according to claim 1, wherein the channel comprises a length measured along the downstream direction from the inlet to the outlet of 100 millimeters or less.

35. A static mixer according to claim 1, wherein the body comprises a flexible body.

36. A static mixer according to claim 1, wherein the downstream direction comprises a curvilinear path that varies in three dimensions.

37. An integrated fluid system comprising, in one unitary body, at least the following components:
a static mixer according to claim 1;
a first chamber located upstream of the static mixer;
a second chamber located downstream of the static mixer; and
fluid connection channels extending between the static mixer, the first chamber, and the second chamber.

38. An immunoassay device, comprising the static mixer of claim 1.
